(19) United States
(12) Patent Application Publication
(10) Pub. No.: US 2011/0232600 A1
(43) Pub. Date: Sep. 29, 2011

(54) BARREL-TYPE INTERNAL COMBUSTION ENGINE AND/OR PISTON ACTUATED COMPRESSOR WITH OPTIMAL PISTON MOTION FOR INCREASED EFFICIENCY

(75) Inventor: DOUGLAS EDWARD HAHN, Virginia Beach, VA (US)

(73) Assignee: AXIAL VECTOR ENERGY CORPORATION, Dubai (AE)

(21) Appl. No.: 12/877,312

(22) Filed: Sep. 8, 2010

Related U.S. Application Data
(60) Provisional application No. 61/318,625, filed on Mar. 29, 2010.

(51) Int. Cl. F02B 75/32

(52) U.S. Cl. 123/197.4

(57) ABSTRACT

A barrel-type piston-actuated internal combustion engine or pump has a drive shaft with an attached drive cam rotatably disposed within a housing. The drive cam has cam surfaces on at least one side facing a piston and cylinder. A cam follower, attached to a piston rod, is in contact with and follows the cam surfaces of the drive cam, such that rotation of the drive shaft with the drive cam results in linear reciprocating motion of the piston rod and its associated piston, and vice versa. The cam surfaces of the drive cam are cyclical in the circumferential direction in accordance with a non-sinusoidal function that controls the motion of the piston within its cylinder. The cam surfaces, and thus the piston motion, are designed and tailored to achieve desired combustion characteristics, in the case of an internal combustion engine, or pumping characteristics in the case of a pump.

### CROSS-REFERENCE TO RELATED APPLICATION

This patent application claims priority from provisional application No. 61/318,625 filed Mar. 29, 2010.

### FIELD OF THE INVENTION

The present invention relates to internal combustion engines and pumps, and more particularly, to an improved cam driven, barrel-type internal combustion engine and/or pump with improved performance.

### BACKGROUND OF THE INVENTION

Various types of an internal combustion engine or “ICE” are known in the art. The most common ICE are the Otto and Diesel engines, utilizing one or more pistons and connecting rods to drive a crankshaft. The Wankel engine, (so-called “rotary engine”) uses an eccentric gear to translate the movement of a triangular rotor, turning on a moving center, into rotation of a drive shaft. A third type of ICE is the “barrel-type” engine wherein a cam driver, connected to follow the linear reciprocating motion of the piston, rotates a sinusoidal drive cam or “swash plate” on a drive shaft. This engine is capable of higher efficiencies, lighter weight and less moving parts than the conventional Otto and Diesel (crankshaft) engines. A crankshaft engine requires movement of numerous counterweights and/or a flywheel to control inertial vibration.

A variety of configurations of cam driven, barrel-type internal combustion engines are disclosed in the literature. An early example is the U.S. Pat. No. 2,243,817 to Herrmann which teaches the basic design of this type of engine. In the U.S. Pat. No. 4,492,188 to Palmer, the engine blocks have an elongate tubular bearing that serves to support the drive shaft. The cam is removably secured to the drive shaft by bolts and rotates between conventional thrust bearings to counteract the lateral pressure on the cam. The U.S. Pat. No. 5,749,337 to Palatov discloses a barrel-type, two-stroke engine with both power pistons and air compressor pistons on opposite sides of the main drive cam.

The barrel-type ICE, also known as a “linear propulsion” engine, may be operated as either a spark ignition or a compression ignition engine, and may be designed and operated as either a two-stroke or a four-stroke engine.

The barrel-type configuration may also be used as a fluid pump, either for liquids or for gases (e.g. air), wherein the main cam drive imparts energy to the pistons and causes their reciprocating motion. The most common use of such a piston-actuated pump (“PAP”) is as a compressor for gases, for example as an air compressor or as a gaseous refrigerant compressor for a refrigeration system, however any type of fluid may be driven (pumped) by this PAP.

The barrel-type ICE or PAP may have pistons on both sides of the main drive cam, or on only one side. It may have multiple pistons on one or both sides of the drive cam, or only a single piston on one or both sides. When multiple pistons are provided, they are arranged in parallel cylinders, making the engine or pump extremely compact.

As shown in the U.S. Pat. No. 5,749,337 to Palatov, referred to above, it is possible to provide both ICE pistons and PAP pistons in the same machine, either on opposite sides of the main drive cam or on the same side.

In all known barrel-type internal combustion engines and piston-actuated pumps, the main drive cam, which converts the linear motion of the pistons into rotary motion of the drive shaft, or vice versa, is provided with cam surfaces that form a sinusoid around its circumference, so that the piston motion is constrained to be sinusoidal in time. This piston motion thus closely resembles the piston motion of a crankshaft engine, which piston motion comes close to, but is not precisely, sinusoidal. The slight variance from sinusoidal motion is due to the geometry of the engine configuration, as the connecting rod follows the crankshaft pin through a complete cycle of rotation.

Current piston internal combustion engines of all types range in efficiency from 35% to 40%. The U.S. Department of Energy (DOE) has conducted extensive research to demonstrate the feasibility of achieving 55% engine efficiency in the laboratory while meeting prevailing emissions standards, and to simulate advanced thermodynamic strategies that will enable engines to approach 60% efficiency. With current piston engine designs, thermal efficiencies higher than about 60% are not believed possible.

### SUMMARY OF THE INVENTION

It is a principal objective of the present invention to provide a piston-actuated internal combustion engine (“ICE”) and/or a piston-actuated pump (“PAP”) which is/are capable of improved performance over what was previously thought possible.

It is a more particular objective of the present invention to provide a barrel-type ICE and/or PAP with increased thermal efficiency over such engines and pumps heretofore known.

It still another objective of the present invention to provide a barrel-type ICE and/or PAP which is specifically designed to achieve particular desired operating characteristics, such as increased thermal efficiency, reduced pollution, reduced friction, cooler operation, longer useful operating life, and the like.

These objectives, as well as further objectives which will become apparent from the discussion that follows, are achieved, in accordance with the present invention, by providing a barrel-type ICE and/or PAP in which the piston motion is not sinusoidal, as is previously known, but has been modified to achieve the particular operating characteristics sought by the designing engineer.

Unlike conventional engines, which have only two variables to define piston motion—namely, piston stroke length (prescribed by the crankshaft) and piston rod length—the barrel-type ICE and/or PAP uses the main drive cam to define piston motion. According to the present invention, this drive cam is machined to achieve the desired, optimal piston motion for the particular engine or pump.

The barrel-type ICE or PAP according to the invention has a drive shaft with an attached drive cam rotatably disposed within a housing. The drive cam has cam surfaces on at least one side, facing a piston and cylinder. A cam follower, attached to a piston rod, is in contact with and follows the cam surfaces of the drive cam, such that rotation of the drive shaft with the drive cam results in linear reciprocating motion of the piston rod and its associated piston (e.g., when in pump mode), and vice versa (e.g., when in engine mode). The cam surfaces of the drive cam are cyclical in the circumferential direction in accordance with a particular non-sinusoidal curve that controls the motion of the piston within its cylinder. The cam surfaces, and thus the piston motion, are designed and tailored to achieve desired combustion characteristics, in the case of an internal combustion engine, or pumping characteristics in the case of a pump.

Advantageously, in the ICE, the cam surfaces cause a higher finite velocity of the piston at the beginning of the compression stroke, as compared to a sinusoidal movement with the same cyclic frequency.

Advantageously also, the cam surfaces cause a small deceleration and then a brief acceleration of the piston, near the end of the compression stroke, as compared to sinusoidal movement with the same cyclic frequency.

In addition, in the preferred embodiment of the invention, the cam surfaces of the engine cause a brief zero movement period, at the top dead center position of the piston at the end of a compression stroke, as compared to sinusoidal movement with the same cyclic frequency. In this case, the cam surfaces cause the piston to accelerate faster during a power stroke as compared to sinusoidal movement at the same cyclic frequency, to make up for the zero movement time at top dead center.

In another preferred embodiment of the present invention the cam surfaces cause the piston to move slower during the first half of the compression stroke, as compared to sinusoidal movement at the same cyclic frequency, to allow for heat transfer from cylinder walls to gases within the cylinder. Advantageously, the cam surfaces also subsequently cause the piston to move faster at the end of the compression stroke, as compared to sinusoidal movement at the same cyclic frequency, to prevent heat loss from gases within the cylinder to the cylinder walls. Advantageously, the cam surfaces cause the piston motion to begin acceleration during a compression stroke when thermal equilibrium occurs between the cylinder walls and gases within the cylinder.

Similar considerations also apply to the piston motion when operating as a pump, except that interruption of the motion at TDC, to allow for combustion to commence, is unnecessary.

The foregoing and other objects, features and advantages of the invention will be apparent from the following more particular description of the invention, as illustrated in the accompanying drawings.

### BRIEF DESCRIPTION OF THE DRAWINGS

FIG. 1 is a cutaway view of a barrel-type internal combustion engine (ICE) and/or piston-actuated pump (PAP) with pistons disposed on both sides of a main drive cam.

FIG. 2 is a diagram representing preferred piston motion, according to the invention, for a four-stroke ICE during one complete cycle of operation.

FIG. 3 is a detailed diagram showing the piston motion of FIG. 2 during the compression stroke and power stroke of the engine.

FIG. 4, is a detailed diagram, similar to that of FIG. 3, showing the preferred piston motion of a PAP according to the invention.

### DETAILED DESCRIPTION OF THE PREFERRED EMBODIMENTS

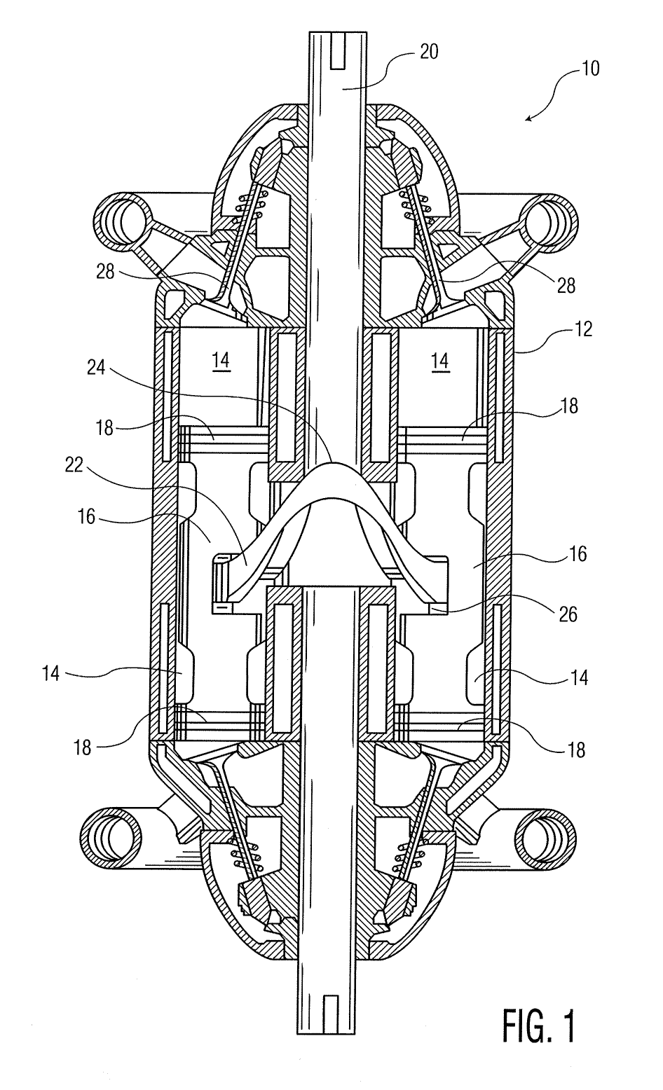

The preferred embodiments of the present invention will now be described with reference to FIGS. 1-4 of the drawings. Identical elements in the various figures are designated with the same reference numerals.

FIG. 1 is a cutaway view of a barrel-type internal combustion engine (ICE) and/or piston-actuated pump (PAP) 10 of the type having a plurality of pistons on both sides of the main drive cam. It will be understood that the pistons can be disposed on one side only, and that the machine can be configured with only one piston on either one or on both sides of the drive cam.

Referring to FIG. 1, the machine includes a main housing 12 or “block” in which are machined a plurality of cylinders 14, arranged in parallel. Disposed within the cylinders are connecting rods 16 formed integrally with pistons 18. These connecting rods can also be connected in articulated fashion, or connected rigidly, to the respective pistons. Each piston/connecting rod/piston arrangement is designed to reciprocate within the respective cylinders surrounding each piston and to either drive, or be driven by, a rotating main drive shaft 20. The conversion between reciprocating motion of the pistons 18 and rotational motion of the drive shaft 20 is effected by a main drive cam 22 having cam surfaces 24 that act on cam follower rollers 26 located in, and reciprocating with, the respective connecting rods 16. The number of times that the pistons reciprocate for each complete revolution of the drive shaft is determined by the number of “rises” in the drive cam 22; i.e. two rises of the cam 22 around its circumference allow the pistons 18 to reciprocate twice, and thus complete one full operating cycle in a four-stroke engine or complete two such cycles in a two-stroke engine. If the drive cam has four rises, then a four-stroke engine would complete two operating cycles, whereas a two-stroke engine would complete four such cycles, for each full rotation of the drive shaft 20.

The machine operates either as an internal combustion engine or as a pump, and as either a four-stroke or two-stroke engine or a two-stroke pump, respectively, as determined by the arrangement and operation of the intake and exhaust valves 28 at the end of each cylinder. These valves, which may instead be reed valves or other types of valves, control the passage of fluids between intake and exhaust manifolds and the respective cylinders.

As noted previously, the main drive cam 22 is conventionally designed with a cam surface 24 on either one or both sides (depending upon wither the machine has pistons on one or both face sides of this cam) which forms a sinusoid around the main rotational axis, thus prescribing pure sinusoidal motion of the piston(s) with respect to time if the drive shaft rotates at constant speed.

According to the present invention, however, the cam surface is not sinusoidal around the cam circumference, but rather is preferably machined for an ICE to match the piston motion with fuel burn so as to optimize cylinder pressures and temperatures in such a way as to increase thermal efficiency and reduce emissions.

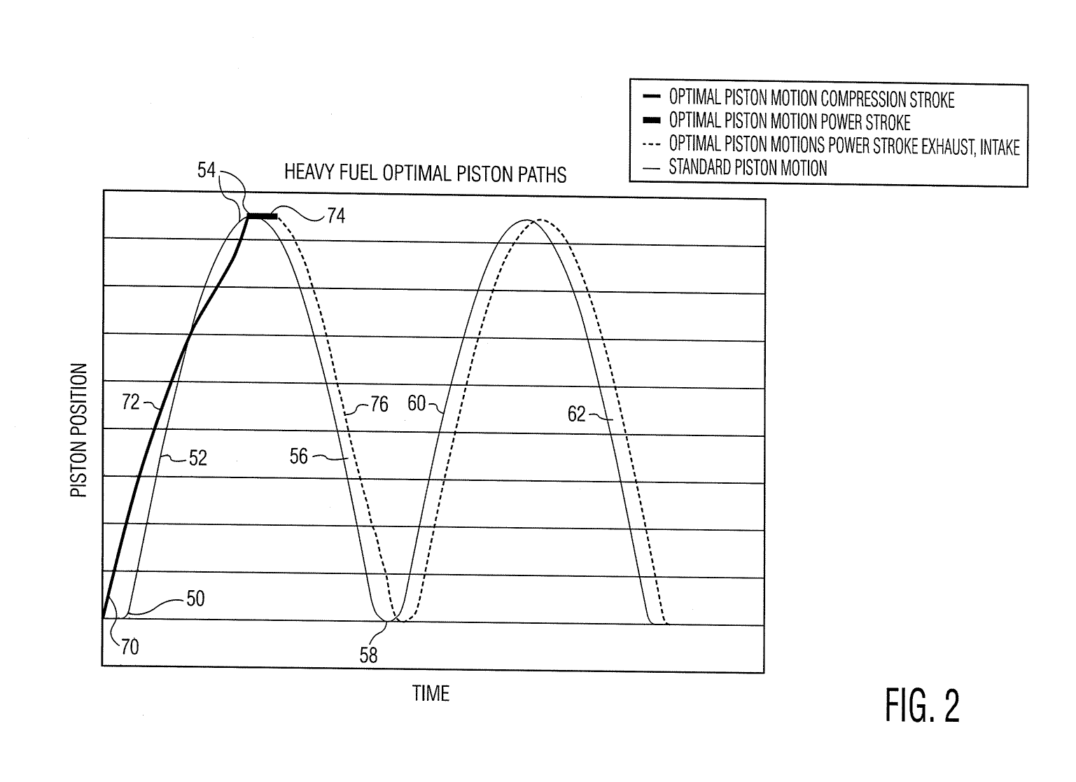

FIG. 2 shows the piston position versus time for a barrel-type ICE operating as a four-stroke engine. The graph line or curve 50 is the well-known, standard sinusoid, with the piston commencing with the compression stroke 52, arriving at top dead center (“TDC”) 54, followed by the power stroke 56 until it reaches bottom dead center (“BDC”) 58. The sinusoidal motion continues with the exhaust stroke 60 and the intake stroke 62 of the piston, and then repeats with the next compression stroke in the operating cycle.

FIG. 2 also shows how the piston motion may be varied in accordance with the present invention to achieve greater thermal efficiency. A second graph line or curve 70 shows the piston motion of a second but identical engine with the cam surface(s) of the main drive cam machined, at least in part, in a non-sinusoidal manner. For better illustration (to avoid overlap of the curves 50 and 70) the engine with the piston motion curve 70 operates at a slightly slower RPM than the engine with the motion curve 50.

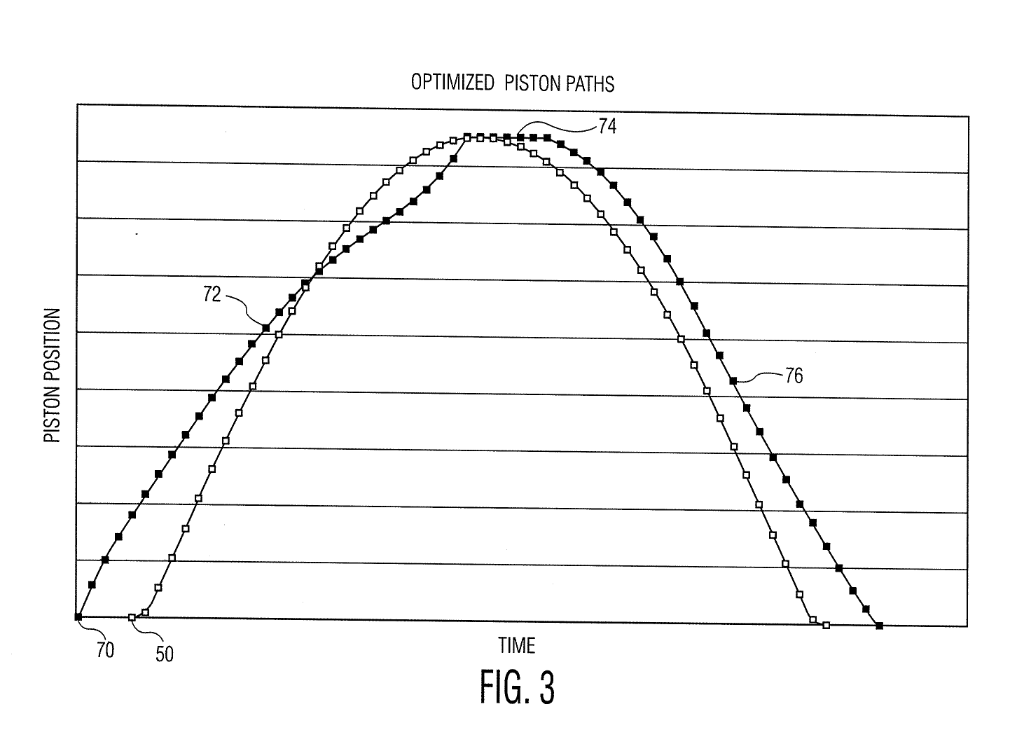

As may be seen, the curve 70 differs from a sinusoid during the compression stroke 72, the TDC 74 and the beginning of the power stroke 76. These portions of the curve are reproduced in greater detail in FIG. 3.

If the engine is operated in the two-stroke mode, the piston motion would still be sinusoidal for the standard engine so the curve 50 would remain the same. However, for a two-stroke engine according to the present invention, the first half (a complete cycle) of the curve 70 would be repeated, without an intermediate sinusoidal movement during an exhaust and intake stroke. In other words, the second half of the curve 70 of FIG. 2 would be identical to the first half that is shown.

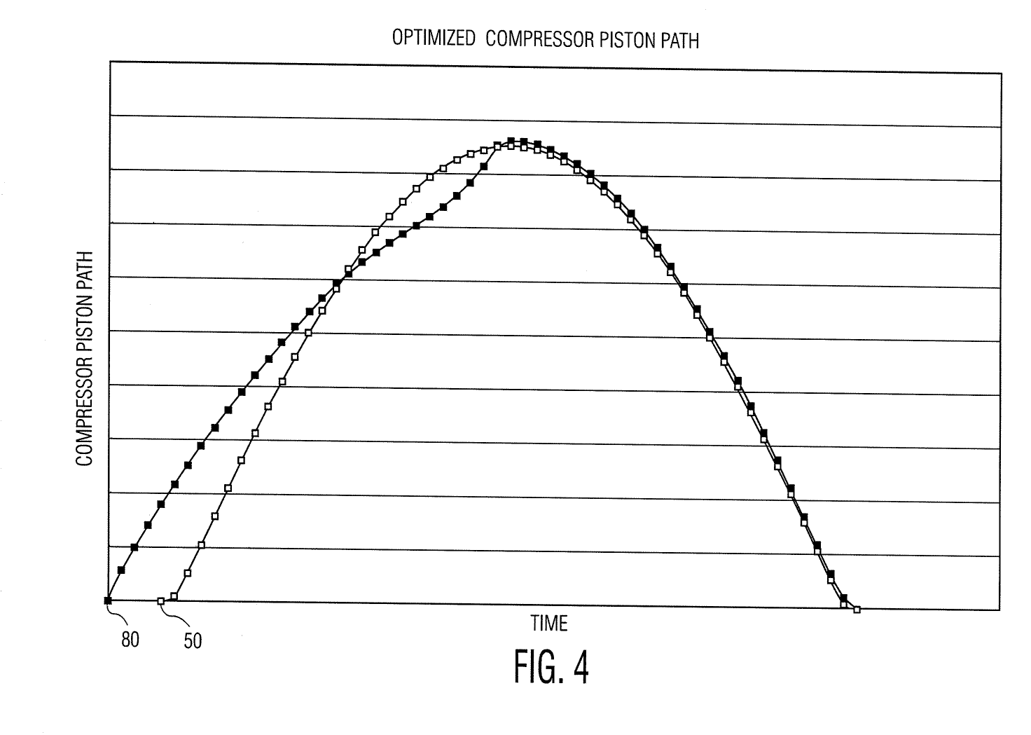

According to the invention, the piston motion for the machine operated as a pump is similar to that of the two-stroke engine, except for a reduced dwell at TDC. FIG. 4 illustrates, in detail, the preferred piston motion 80 for a PAP, in comparison with pure sinusoidal motion 50.

When operating as an engine, the piston motion of the machine starts with a fixed velocity and then decelerates in the middle part of the compression stroke to allow for heat transfer from the cylinder walls to the gases within the cylinder. Once the gases and walls reach thermal equilibrium the process reverses itself as the gases begin to transfer heat back to the walls. In order to prevent this loss of energy, the piston is accelerated to TDC. The heat loss and the work due to compression are minimized if the point where equilibrium occurs is immediately prior to ignition. The piston is then allowed to dwell briefly at TDC to give combustion time to commence, and it thereafter moves downward with an almost constant velocity during the remainder of the power stroke. Since the piston dwells at TDC it must move to BDC quicker than in the conventional engine; however, the increased thermal efficiency outweighs the increase in friction from this additional velocity. The dwell at TDC minimizes the heat loss to cylinder walls with higher peak temperatures and lower exhaust temperatures.

Research on the relationship of piston motion to combustion is summarized a treatise, The Thermodynamics of Energy Conversion and Transport, Stanislaw Sieniutycz and Alexis De Vos, editors, (ISBN0-387-98938-2), the entire content of which is incorporated herein by reference. See, for example, Chapter 7, entitled “Optimal Piston Paths for Diesel Engines” written by J. M. Burzler, P. Blaudeck and K. H Hoffman. The graphs of FIGS. 2 and 3 have been derived from graphs in this book; however, they will vary depending upon engine speed, cylinder size, operating temperature and other engine variables.

According to this text, the optimal motion of the piston deviates from sinusoidal motion because of the heat leakage and the volume work performed. Initially, the walls of a cylinder are hotter than the working fluid and the relatively colder gas receives heat from these walls. Eventually the temperature of the working fluid becomes higher than the wall temperature and the direction of heat flow switches from inward to outward. The heat losses and compression work are minimized if the switching point is reached just prior to ignition.

Research studies reported in this treatise indicate there is very little benefit from changing the piston motion during the exhaust and intake cycles of an engine. Consequently, the remainder of the two-stroke or four-stroke cycle is preferably sinusoidal, to allow for smooth operation.

When operating as a pump, similar considerations apply to the piston motion, except that the brief interruption of motion at TDC, to allow for combustion to commence, is unnecessary.

There has thus been shown and described an improved internal combustion engine and/or piston-actuated pump which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. A barrel-type internal combustion engine (ICE) comprising, in combination:
(a) an ICE housing having a first end and a second end;
(b) an elongated drive shaft longitudinally disposed within the housing and defining a longitudinal axis of the ICE from said first end to said second end;
(c) a drive cam disposed within the housing and rigidly mounted on, and rotatable with, the drive shaft, said drive cam having a cam surface on one side thereof facing said first end of the ICE;
(d) at least one cylinder disposed in said housing at said first end, each cylinder having a central axis arranged in parallel with said longitudinal axis;
(e) a piston arranged for reciprocating movement within each cylinder, said piston having a top portion and a bottom portion;
(f) a piston rod connected to the bottom portion of said piston and extending parallel to said longitudinal axis toward said second end; and
(g) a cam follower attached to each piston rod and in contact with said cam surface of said drive cam, such that rotation of said drive shaft with said drive cam results in linear reciprocating motion of said piston rod and vice versa;
wherein said at least one cylinder forms a combustion chamber between the top portion of the piston arranged for movement within said one cylinder and the corresponding end of said one cylinder, and
wherein the cam surface of said drive cam is cyclical in the circumferential direction in accordance with a non-sinusoidal function that prescribes said motion of said piston within said one cylinder to achieve desired combustion characteristics within the combustion chamber.

2. The ICE recited in claim 1, wherein there are multiple cycles in the cam surface in one complete rotation of the cam.

3. The ICE recited in claim 1, wherein a plurality of cylinders are disposed in parallel at said first end of said housing, with the central axes of all cylinders equidistant from said longitudinal axis of said ICE.

4. The ICE recited in claim 1, wherein the cam surface causes a finite velocity of movement of said piston at the beginning of a compression stroke, as compared to a sinusoidal movement with the same cyclic frequency.

5. The ICE recited in claim 1, wherein the cam surface causes a small deceleration, and then a brief acceleration, of said piston near the end a compression stroke, as compared to sinusoidal movement with the same cyclic frequency.

6. The ICE recited in claim 1, wherein the cam surface causes a brief zero movement period, at a top dead center position of said piston, at the end of a compression stroke, as compared to sinusoidal movement with the same cyclic frequency.

7. The ICE recited in claim 1, wherein the cam surface causes the piston to accelerate faster, during a power stroke, as compared to sinusoidal movement at the same cyclic frequency.

8. The ICE recited in claim 1, wherein the cam surface causes the piston to move slower during the first half of the compression stroke, as compared to sinusoidal movement at the same cyclic frequency, to allow for heat transfer from cylinder walls to gases within the cylinder.

9. The ICE recited in claim 1, wherein the cam surface causes the piston to move faster at the end of the compression stroke, as compared to sinusoidal movement at the same cyclic frequency, to prevent heat loss from gases within the cylinder to the cylinder walls.

10. The ICE recited in claim 1, wherein the cam surface causes the piston to begin acceleration during a compression stroke when thermal equilibrium has occurred between cylinder walls and gases within the cylinder.

11. A barrel-type, piston-actuated pump (PAP) comprising:
(a) a PAP housing having a first end and a second end;
(b) an elongated drive shaft longitudinally disposed within the housing and defining a longitudinal axis of the PAP from said first end to said second end;
(c) a drive cam disposed within the housing and rigidly mounted on, and rotatable with, the drive shaft, said drive cam having a cam surface on one side thereof facing said first end of the PAP;
(d) at least one cylinder disposed in said housing at said first end, each cylinder having a central axis arranged in parallel with said longitudinal axis;
(e) a piston arranged for reciprocating movement within each cylinder, said piston having a top portion and a bottom portion;
(f) a piston rod connected to the bottom portion of said piston and extending parallel to said longitudinal axis toward said second end; and
(g) a cam follower attached to each piston rod and in contact with said cam surface of said drive cam, such that rotation of said drive shaft with said drive cam results in linear reciprocating motion of said piston rod and vice versa;
wherein said at least one cylinder forms a pumping chamber between the top portion of the piston arranged for movement within said one cylinder and the corresponding end of said one cylinder, and
wherein the cam surface of said drive cam is cyclical in the circumferential direction in accordance with a non-sinusoidal function that prescribes said motion of said piston within said one cylinder to achieve desired pumping characteristics within the pumping chamber.

12. The PAP recited in claim 11, wherein there are multiple cycles in the cam surface in one complete rotation of the cam.

13. The PAP recited in claim 11, wherein a plurality of cylinders are disposed in parallel at said first end of said housing, with the central axes of all cylinders equidistant from said longitudinal axis of said PAP.

14. The PAP recited in claim 11, wherein the cam surface causes higher finite velocity of movement of said piston at the beginning of a compression stroke, as compared to a sinusoidal movement with the same cyclic frequency.

15. The PAP recited in claim 11, wherein the cam surface causes a small deceleration, and then a brief acceleration, of said piston near the end a compression stroke, as compared to sinusoidal movement with the same cyclic frequency.

16. The PAP recited in claim 11, wherein the cam surface causes the piston to move slower during the first half of the compression stroke, as compared to sinusoidal movement at the same cyclic frequency, to allow for heat transfer from cylinder walls to gases within the cylinder.

17. The PAP recited in claim 11, wherein the cam surface causes the piston to move faster at the end of the compression stroke, as compared to sinusoidal movement at the same cyclic frequency, to prevent heat loss from gases within the cylinder to the cylinder walls.

18. A barrel-type internal combustion engine (ICE) comprising, in combination:
(a) an ICE housing having a first end and a second end;
(b) an elongated drive shaft longitudinally disposed within the housing and defining a longitudinal axis of the ICE from said first end to said second end;
(c) a drive cam disposed within the housing and rigidly mounted on, and rotatable with, the drive shaft, said drive cam having cam surfaces on opposite sides thereof facing said first end and said second end of the ICE;
(d) at least one cylinder disposed in said housing at each of said first end and said second end, each cylinder having a central axis arranged in parallel with said longitudinal axis, the central axis of each cylinder at the first end being in alignment with the central axis of a corresponding cylinder at the second and;
(e) a piston arranged for reciprocating movement within each cylinder, said piston having a top portion and a bottom portion;
(f) a piston rod connecting the bottom portion each piston within a cylinder at the first end with the bottom portion of each piston within the corresponding cylinder at the second end; and
(g) a cam follower attached to each piston rod and in contact with said cam surfaces of said drive cam, such that rotation of said drive shaft with said drive cam results in linear reciprocating motion of said piston rod and vice versa;
wherein said at least one cylinder forms a combustion chamber between the top portion of the piston arranged for movement within said one cylinder and the corresponding end of said one cylinder, and
wherein the cam surfaces of said drive cam are cyclical in the circumferential direction in accordance with a non-sinusoidal function that prescribes said motion of said piston within said one cylinder to achieve desired combustion characteristics within the combustion chamber.

19. The ICE recited in claim 18, wherein there are multiple cycles of the cam surfaces in one complete rotation of the cam.

20. The ICE recited in claim 18, wherein a plurality of cylinders are disposed at each end of said housing, with the central axes of all cylinders equidistant from said longitudinal axis of said ICE.

21. The ICE recited in claim 18, wherein the cam surface causes higher finite velocity of movement of said piston at the beginning of a compression stroke, as compared to a sinusoidal movement with the same cyclic frequency.

22. The ICE recited in claim 18, wherein the cam surface causes a small deceleration, and then a brief acceleration, of said piston near the end a compression stroke, as compared to sinusoidal movement with the same cyclic frequency.

23. The ICE recited in claim 18, wherein the cam surface causes a brief zero movement period, at a top dead center position of said piston, at the end of a compression stroke, as compared to sinusoidal movement with the same cyclic frequency.

24. The ICE recited in claim 18, wherein the cam surface causes the piston to accelerate faster, during a power stroke, as compared to sinusoidal movement at the same cyclic frequency.

25. The ICE recited in claim 18, wherein the cam surface causes the piston to move slower during the first half of the compression stroke, as compared to sinusoidal movement at the same cyclic frequency, to allow for heat transfer from cylinder walls to gases within the cylinder.

26. The ICE recited in claim 18, wherein the cam surface causes the piston to move faster at the end of the compression stroke, as compared to sinusoidal movement at the same cyclic frequency, to prevent heat loss from gases within the cylinder to the cylinder walls.

27. The ICE recited in claim 18, wherein the cam surface causes the piston to begin acceleration during a compression stroke when thermal equilibrium occurs between cylinder walls and gases within the cylinder.

28. The ICE recited in claim 18, wherein at least one cylinder forms a pumping chamber between the top portion of the piston arranged for movement within said one cylinder and the corresponding end of said one cylinder, and
wherein the cam surfaces of said drive cam are cyclical in the circumferential direction in accordance with a non-sinusoidal function that prescribes said motion of a pumping piston within said one cylinder to achieve desired pumping characteristics in the pumping chamber.

29. The ICE recited in claim 28, wherein the cam surface causes higher finite velocity of movement of said pumping piston at the beginning of a compression stroke, as compared to a sinusoidal movement with the same cyclic frequency.

30. The ICE recited in claim 28, wherein the cam surface causes a small deceleration, and then a brief acceleration, of said pumping piston near the end a compression stroke, as compared to sinusoidal movement with the same cyclic frequency.

31. The ICE recited in claim 28, wherein the cam surface causes the pumping piston to move slower during the first half of the compression stroke, as compared to sinusoidal movement at the same cyclic frequency, to allow for heat transfer from cylinder walls to gases within the cylinder.

32. The ICE recited in claim 28, wherein the cam surface causes the pumping piston to move faster at the end of the compression stroke, as compared to sinusoidal movement at the same cyclic frequency, to prevent heat loss from gases within the cylinder to the cylinder walls.

33. The ICE recited in claim 28, wherein at least one cylinder on one end of the housing forms a combustion chamber and least one cylinder on an opposite end of the housing forms a pumping chamber.

34. The ICE recited in claim 33, wherein all the cylinders at on one end of the housing form combustion chambers and all the cylinders on an opposite end of the housing form pumping chambers.

35. A barrel-type piston-actuated pump (PAP) comprising:
(a) a PAP housing having a first end and a second end;
(b) an elongated drive shaft longitudinally disposed within the housing and defining a longitudinal axis of the PAP from said first end to said second end;
(c) a drive cam disposed within the housing and rigidly mounted on, and rotatable with, the drive shaft, said drive cam having cam surfaces on opposite sides thereof facing said first end and said second end of the PAP;
(d) at least one cylinder disposed in said housing at each of said first end and said second end, each cylinder having a central axis arranged in parallel with said longitudinal axis, the central axis of each cylinder at the first end being in alignment with the central axis of a corresponding cylinder at the second and;
(e) a piston arranged for reciprocating movement within each cylinder, said piston having a top portion and a bottom portion;
(f) a piston rod connecting each piston within a cylinder at the first end with the piston within the corresponding cylinder at the second end; and
(g) a cam follower attached to each piston rod and in contact with said cam surfaces of said drive cam, such that rotation of said drive shaft with said drive cam results in linear reciprocating motion of said piston rod and vice versa;
wherein said at least one cylinder forms a pumping chamber between the top portion of the piston arranged for movement within said one cylinder and the corresponding end of said one cylinder, and
wherein the cam surfaces of said drive cam are cyclical in the circumferential direction in accordance with a non-sinusoidal function that that prescribes said motion of said piston within said one cylinder to achieve desired pumping characteristics in said pumping chamber.

36. The PAP recited in claim 35, wherein there are multiple cycles of the cam surfaces in one complete rotation of the cam.

37. The PAP recited in claim 35, wherein a plurality of cylinders are disposed at each end of said housing, with the central axes of all cylinders equidistant from said longitudinal axis of said PAP.

38. The PAP recited in claim 35, wherein the cam surface causes higher finite velocity of movement of said piston at the beginning of a compression stroke, as compared to a sinusoidal movement with the same cyclic frequency.

39. The PAP recited in claim 35, wherein the cam surface causes a small deceleration, and then a brief acceleration, of said piston near the end a compression stroke, as compared to sinusoidal movement with the same cyclic frequency.

40. The PAP recited in claim 35, wherein the cam surface causes the piston to move slower during the first half of the compression stroke, as compared to sinusoidal movement at the same cyclic frequency, to allow for heat transfer from cylinder walls to gases within the cylinder.

41. The PAP recited in claim 35, wherein the cam surface causes the piston to move faster at the end of the compression stroke, as compared to sinusoidal movement at the same cyclic frequency, to prevent heat loss from gases within the cylinder to the cylinder walls.
